(19) United States
(12) Patent Application Publication
(10) Pub. No.: US 2015/0196814 A1
(43) Pub. Date: Jul. 16, 2015

(54) Single panel golf club grip with a decorative layer

(71) Applicants: Hong-Sung Chu, Alhambra, CA (US); Chiung-Ling Wang Chu, Alhambra, CA (US)

(72) Inventors: Hong-Sung Chu, Alhambra, CA (US); Chiung-Ling Wang Chu, Alhambra, CA (US)

(21) Appl. No.: 13/999,112

(22) Filed: Jan. 14, 2014

(51) Int. Cl. A63B 53/14; B32B 37/24; B32B 38/00; B32B 37/14

(52) U.S. Cl. CPC A63B 53/14; B32B 37/142; B32B 37/24; B32B 38/0008; B32B 38/145; B32B 2037/243

(57) ABSTRACT

A single panel golf club grip includes a resilient inner sleeve and a single panel gripping member. The single panel gripping member has a laminate-layered structure having a panel decorative layer with a photographic image for aesthetical appearance and a contact layer for providing soft anti-slip feel. The photographic image is printed in one digital inkjet printing step in order to simplify and make the printing process cost-effective. An axial central part of the single panel gripping member is aligned with an axial central front area of the resilient inner sleeve for producing better visual effects, improving the good production rate, and proper grip alignment during installation.

### BACKGROUND OF THE INVENTION

1. Field of the Invention

The present invention is related to an improved single panel golf club grip with aesthetical appearance of one-colour or multi-colour inkjet photographic image and soft anti-slip feel for golf players.

2. Description of the Related Art

A golf club grip is principally designed for golf players to hold firmly. In addition, it is getting essential that the golf club grip should exhibit aesthetical appearance on its gripping member to be more appealing.

There are several prior arts disclosing the methods for enhancing the appearance of a single panel golf club grip. This single panel golf club grip usually includes a resilient inner sleeve as the inner layer and a single panel gripping member as the outer layer. Prior art U.S. Pat. No. 6,843,732 disclosed a grip having multi-segment single panel as a gripping member to present multiple colour combination. U.S. Pat. Nos. 7,448,958 and 7,448,957 disclosed a panel golf club grip with inserted and cut-out panels in order to present multiple colours and limited image designs. Above three prior arts create more margins between the colours and designs. These methods disclosed in above three prior arts increase the cost of making the grips and cannot provide photographic images so as to make the produced grips tedious. U.S. Pat. No. 7,347,792 disclosed a single panel grip having two or more polymers in its gripping member to exhibit two or more colours with different appearance patterns. This method is costly to present the combination of two or more colours and cannot provide photographic image either.

Conventionally, during the process of manufacturing a single panel golf club grip, a gripping member is firstly processed by screen printing for decoration, then its contact surface is finished with an anti-slip coating. After that, the processed gripping member is die-cut, wrapped and adhered onto an inner sleeve so as to decorate the single panel golf club grip. However, the screen printing process is cumbersome and has costly steps of film-drying, plate-making, and printing.

Therefore, Applicants have developed the present invention to solve the above problems.

### SUMMARY OF THE INVENTION

It is one object of the present invention to provide an improved single panel golf club grip having an one-colour or multi-colour inkjet photographic image (hereafter referred as “photographic image”) on its single panel gripping member and the soft anti-slip feel for golf players to hold. The photographic image is defined to be a photo image or an image having a colour range and a clear shape as a photo in accuracy or detail, wherein the photo is defined as an image taken by a camera.

It is another object of the present invention to provide an improved single panel golf club grip having a single panel gripping member with a photographic image that is properly located at an axial central front area of the golf club grip in order to produce better visual effects and to have the single panel gripping member properly assembled onto the resilient inner sleeve to increase the good production rate.

It is still another object of the present invention to provide an improved single panel golf club grip having a single panel gripping member with an inkjet photographic image that is printed in a simple and cost effective step.

In order to fulfil the above three objects, the present invention provides a single panel golf club grip comprising a resilient inner sleeve, a single panel gripping member, and an axial seam structure.

The resilient inner sleeve has a tubular sleeve body, a top cap end, a bottom protective rim end, and an axial central front area.

The single panel gripping member has a determined contour having top and bottom margins interconnected with two axial margins, a laminate-layered structure, and at least a panel central mark located at a position in an area from its top margin to bottom margin. The laminate-layered structure has a substrate layer, an ink receiving layer, a panel decorative layer, an image protecting layer, and a contact layer. The panel decorative layer has a photographic image printed in one printing step. The printing step is a digital inkjet printing step.

The combination of the ink receiving layer and panel decorative layer provides the golf club grip with an aesthetical appearance via the photographic image. The contact layer is formed by an anti-slip polymer and is coated on the top of the image protecting layer so as to provide a soft anti-slip feel for golf players.

A central part of the photographic image is preferably aligned with the axial central front area of the resilient inner sleeve in order to provide better visual effects for the golf club grip and improve the good production rate.

The single panel gripping member is wrapped around and adhered onto an outer surface of the tubular sleeve body of the resilient inner sleeve. Then, the two axial margins of the single panel gripping member are connected and finished with the axial seam structure to form the single panel golf club grip with a decorative layer of the present invention.

In some embodiments of the present invention, the single panel gripping member has a colour central mark system located between its top margin and bottom margin. The colour central mark system helps golf players to properly align the golf club grip with respect to the golf club head face during and after the grip installation.

In other some embodiments of the present invention, the substrate layer of the single panel gripping member is a natural leather, such as split leather, or other synthesized material containing collagen fiber, such as bonded leather, which would provide the substrate layer with an improved and upgraded surface. Such substrate layer together with the laminate-layered structure could achieve the three objects of the present invention while additionally provide a natural leather soft feel, natural leather's torque resistant feature with lower prices due to their material's collagen fiber and cost when compared with conventional natural leather golf club grips.

### BRIEF DESCRIPTION OF THE DRAWINGS

Other features and advantages of the present invention will become apparent in the following detailed description of the preferred embodiments with reference to the accompanying drawings, of which:

FIG. 1 is a front side prospective view of a resilient inner sleeve of the present invention.

FIG. 2 is another front side prospective view of the resilient inner sleeve of the present invention in a conventional golf club grip installation direction of mounting a golf club grip onto a golf shaft.

FIG. 3 shows a single panel gripping member's contour of a first embodiment of the present invention.

FIG. 4 shows a single panel gripping member's contour of a second embodiment of the present invention.

FIG. 5 is a partial prospective view of a sheet material of the present invention.

FIG. 6 is a cross-sectional view of the sheet material with an ink receiving layer.

FIG. 7 is a schematic view showing a computer screen on which the digital data of the contour of the present invention from a digital data file is displayed.

FIG. 8 is a schematic view showing a computer screen on which a photographic image digital data and a colour central mark system digital data of the present invention contained in a digital file are displayed.

FIG. 9 is another schematic view showing a computer screen on which a photographic image digital data and a colour central mark system digital data of the present invention contained in a digital file are displayed.

FIG. 10 is a prospective view of the sheet material having a decorative layer.

FIG. 11 is a cross-sectional view of the sheet material having the ink receiving layer and the decorative layer.

FIG. 12 is a cross-sectional view of the sheet material having the ink receiving layer, the decorative layer, and an image protecting layer.

FIG. 13 is a cross-sectional view of the sheet material having the ink receiving layer, the decorative layer, the image protecting layer, and a contact layer.

FIG. 14 is a prospective view of the single panel gripping member of the first embodiment of the present invention.

FIG. 15 is a cross-sectional view of the single panel gripping member of the first embodiment of the present invention.

FIG. 16 is a prospective view of the single panel gripping member of the second embodiment of the present invention.

FIG. 17 is a cross-sectional view of the single panel gripping member of the second embodiment of the present invention.

FIG. 18 shows an assembly step of the first embodiment of the present invention.

FIG. 19 is a front-side prospective view of the first embodiment of the present invention.

FIG. 20 is a back-side prospective view of the first embodiment of the present invention.

FIG. 21 is a cross-sectional view taken along line 21-21 of FIG. 20.

FIG. 22 is a cross-sectional view of the first embodiment of the present invention with an axial seam structure disclosed in a prior art of U.S. Pat. No. 3,857,745.

FIG. 23 is a cross-sectional view of the first embodiment of the present invention with an axial seam structure disclosed in another prior art of U.S. Pat. No. 3,366,384.

FIG. 24 is an enlarged view of circled area (CA) of FIGS. 21, 22, 23.

FIG. 25 shows an assembly step of the second embodiment of the present invention.

FIG. 26 is a front side prospective view of the second embodiment of the present invention.

FIG. 27 is a back side prospective view of the second embodiment of the present invention.

FIG. 28 is a cross-sectional view of line 28-28 of FIG. 27.

FIG. 29 is a cross-sectional view of the second embodiment of the present invention with the axial seam structure disclosed in a prior art of U.S. Pat. No. 3,857,745.

FIG. 30 is a cross-sectional view of the second embodiment of the present invention with the axial seam structure disclosed in another prior art of U.S. Pat. No. 3,366,384.

FIG. 31 is an enlarged view of circled area (CA′) of FIGS. 28, 29, 30.

FIG. 32 is a prospective view of the second embodiment of the present invention that is to be installed onto a golf club.

FIG. 33 is a diagram showing the alignment of three golf club grips in the second embodiment of the present invention that are installed onto the golf clubs.

### DETAILED DESCRIPTION OF THE PREFERRED EMBODIMENTS

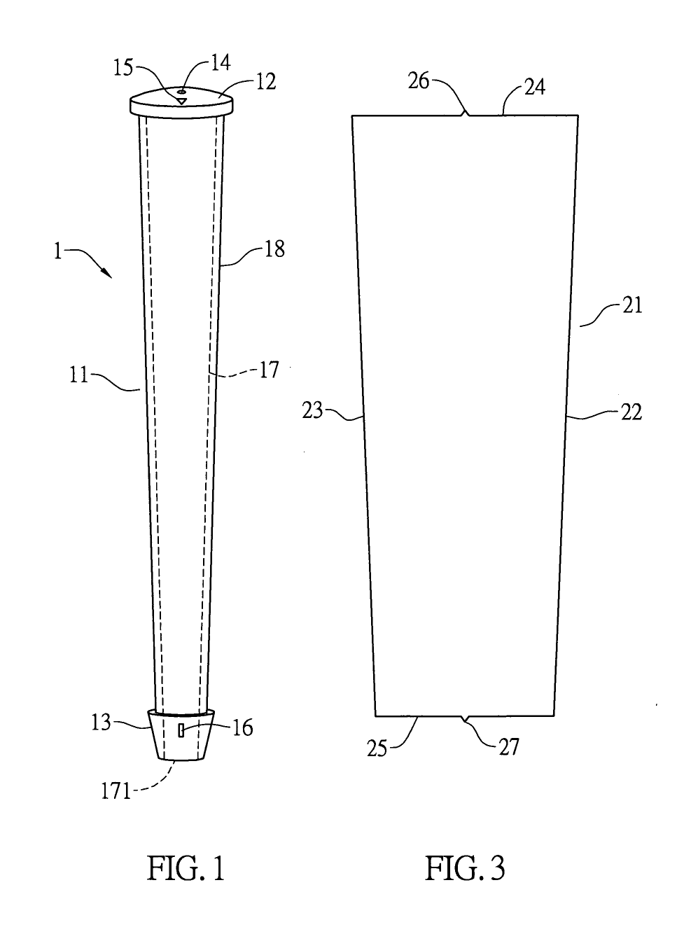

The present invention will be illustrated from FIGS. 1 to 33, wherein the same elements are represented with the same reference number.

The present invention provides a single panel golf club grip A or B comprising a resilient inner sleeve 1, a single panel gripping member (2A or 2B), and an axial seam structure 3. The resilient inner sleeve 1 is made-of expandable polymeric materials selected from a group of natural rubber, rubber compound, thermoplastic elastomer (TPE), thermoplastic rubber (TPR), any suitable plastic, and closed-cell foams of plastic or rubber. It is formed through a moulding process.

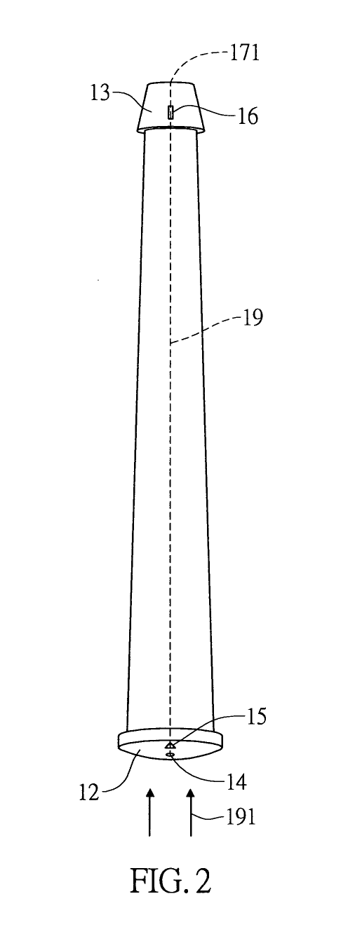

Referring to FIG. 1 and 2, the resilient inner sleeve 1 includes a tubular sleeve body 11 which has circular cross-section throughout its length, a cap 12 projecting radially from a first end of the tubular sleeve body 11 and closed with a vent hole 14, a protective rim 13 projecting radially from a second end of the tubular sleeve body 11 and provided with an opening 171, a cavity 17 configured to receive the larger end of the golf club shaft, an axial central front area 19 between the vent hole 14 and the opening 171, and an outer surface 18 of the tubular sleeve body 11 extended from the cap 12 to the protective rim 13. The axial central front area 19 is defined as a designated central area being marked by means of two sleeve central marks 15, 16 or by means of a reference mark on the resilient inner sleeve 1 and a colour laser beam emitted from a pointer device, wherein the colour laser beam is projected during an assembling step (that will be described later) to mark the designated central area in the path of a conventional grip installation direction 191 along which the grip is mounted onto the golf club shaft (FIG. 2). The two sleeve central marks 15, 16 are respectively located at the cap 12 and the protective rim 13.

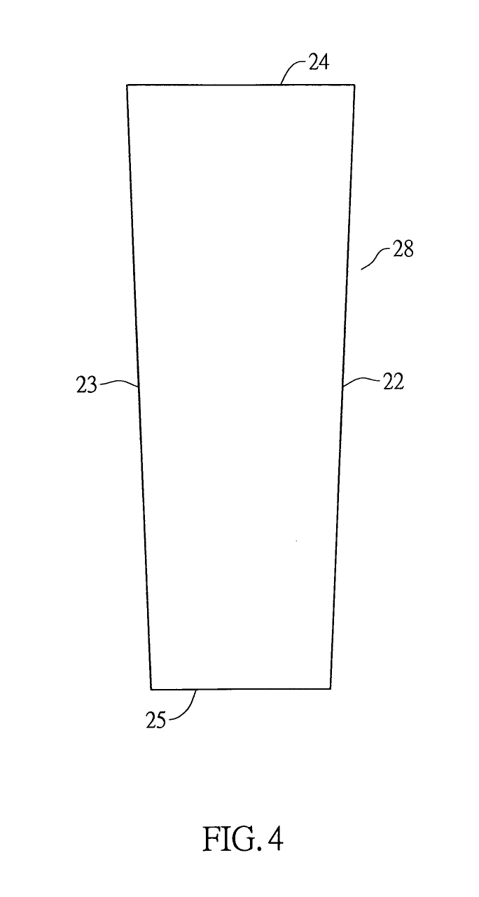

The single panel gripping member (2A or 2B) has a top margin 24, a bottom margin 25, two axial margins 22, 23, and a contour (21 or 28). The two axial margins 22, 23 are equal in length and longer than the top and bottom margins 24, 25. The contour 21 (FIG. 3) includes two panel central marks 26, 27 respectively located at the top and bottom margins 24, 25. Another contour 28 (FIG. 4) has no panel central marks 26, 27 at the top and bottom margins 24, 25. The contour (21 or 28) is determined in such a way that the dimension of the single panel gripping member (2A or 2B) with the axial seam structure 3 (that would be described in details later) should be sufficient to cover the outer surface 18 of the resilient inner sleeve 1.

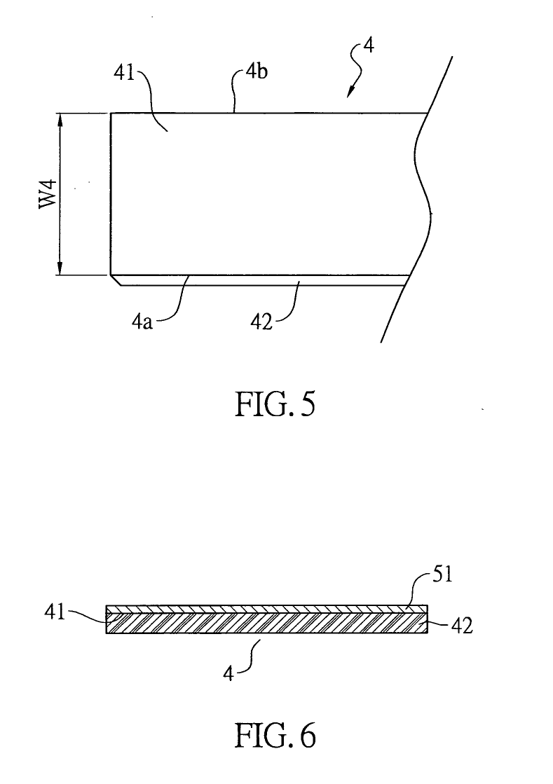

Referring to FIG. 5, the single panel gripping member (2A or 2B) is made of a sheet material 4 including a substrate 42 selected from a group consisting of synthetic leather, PU (Polyurethane) leather, PU wet type leather, PU/closed-cell foam leather, water based PU (Polyurethane) leather, natural leather, leather/closed-cell foam layered materials, split leather, synthesized leather, bonded leather, and other materials containing collagen fiber.

The dimension of the sheet material 4 is larger than the dimensions of the contours 21, 28 of the single panel gripping member (2A or 2B). The sheet material 4 has a width W4 between its edges 4a, 4b and the width W4 is wider than the widths of the top margin 24 and bottom margin 25 of the single panel gripping member (2A or 2B).

An ink receiving coating is sprayed, dried, and coated entirely on one surface 41 of the sheet material 4 between edges 4a and 4b. The coating is cured to form an ink receiving layer 51 adhered on the surface 41 of the sheet material 4 (FIGS. 5, 6). The ink receiving coating is a conventional polymer coating including a water-absorbing polymer, such as a cationic polymer and an anionic polymer, which has sufficient or good water-absorbing capacity to absorb the water content in water based ink of the inkjet printing.

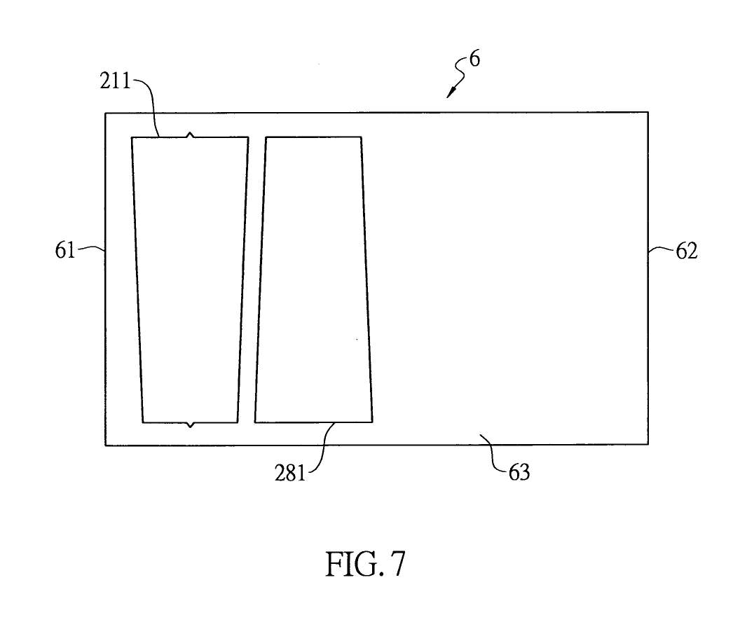

Referring to FIG. 7, digital image data 211, 281 of different contours 21, 28 that are included in a digital data file 6 is displayed on a computer's screen. The digital data file 6 has a left print margin 61 and a right print margin 62 and a digital printing data space 63 between the print margins 61 and 62. The digital printing data space 63 is sufficient to include at least one piece of digital image data of contour 21 or 28, or sufficient to include two or more pieces of digital image data of different contours, such as digital image data 211, 281. The actual printing output width and length of the digital printing data space 63 is smaller than the width (W4) and length of the sheet material 4.

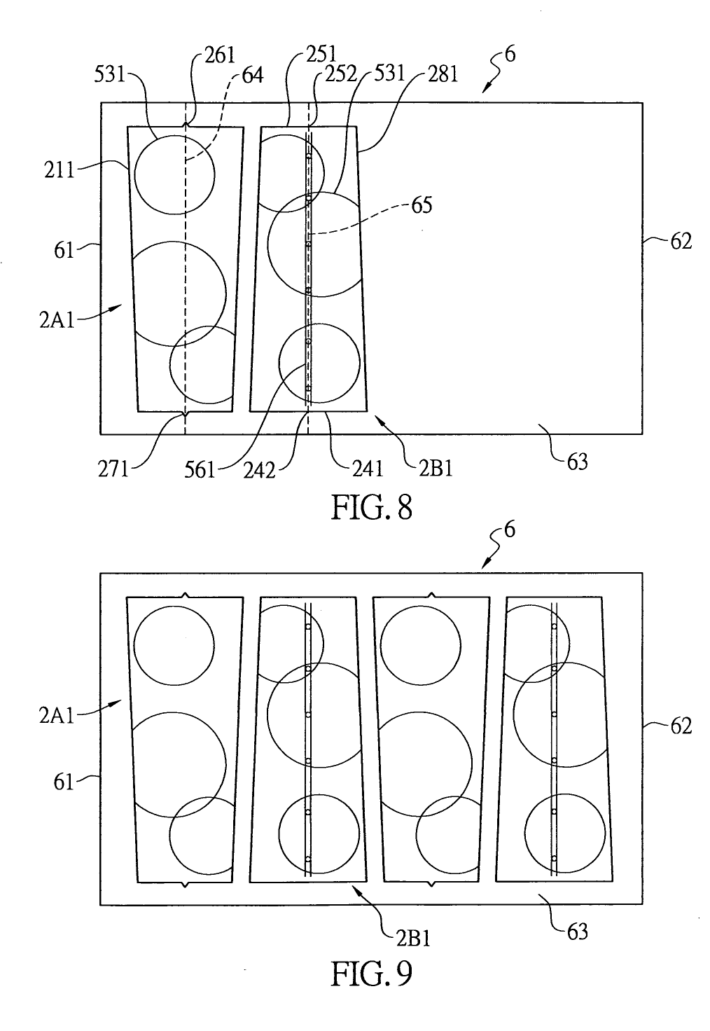

Referring to FIG. 8, a digital image data 531 of a photographic image 53 is input and adjusted to be fit into the image data 211 of the contour 21, and then a proper (or preferred) central part of the digital image data 531 is further adjusted to be aligned with a hypothetical line 64 between the digital data 261, 271 of the contour's panel central marks 26, 27 for better visual effects of the golf club grip A in a first embodiment of the present invention (that will be described in details later). A digital data 2A1 of the single panel gripping member 2A is thus formed. It consists of the digital data 211 of the contour 21 and the digital image data 531 of photographic image 53.

To form another digital data 2B1 of the single panel gripping member 2B, the digital image data 531 of the photographic image 53 and a digital central mark data 561 of a colour central mark system 56 (that will be described in details later) are input and adjusted to be fit into the digital data 281 of the contour 28. There is a hypothetical line 65 between the digital central points 242, 252 of the digital data 241, 251 of the top and bottom margins 24, 25. The digital central mark data 561 and the proper (or preferred) central part of the digital image data 531 are aligned with the hypothetical line 65 for better visual effects of the golf club grip B in a second embodiment of the present invention (that will be described in details later). The digital data 2B1 consists of the digital data 281 of the contour 28, the digital image data 531 of photographic image 53, and the digital central mark data 561 of the colour central mark system 56.

The image digital data 2A1, 2B1 of the single panel gripping members 2A, 2B can be easily adjusted to change their colour or shape as desired at any time after the digital data of the digital data file 6 is input.

Referring to FIG. 9, the image digital data 2A1, 2B1 are duplicated and configured within the digital printing data space 63 in order to make the best use of the sheet material 4 and to have the operation easier for future die-cut step. The digital data file 6 containing the image digital data 2A1, 2B1 is completed.

The sheet material 4, with the ink receiving layer 51 (FIGS. 5 and 6), is placed on a flatbed equipped with an inkjet printer (not shown). The digital image data file 6 is delivered through a computer to the inkjet printer and a digital inkjet printing step is then started. The sheet material 4's width (W4) and length shall be smaller than the inkjet printer's printing output width and length.

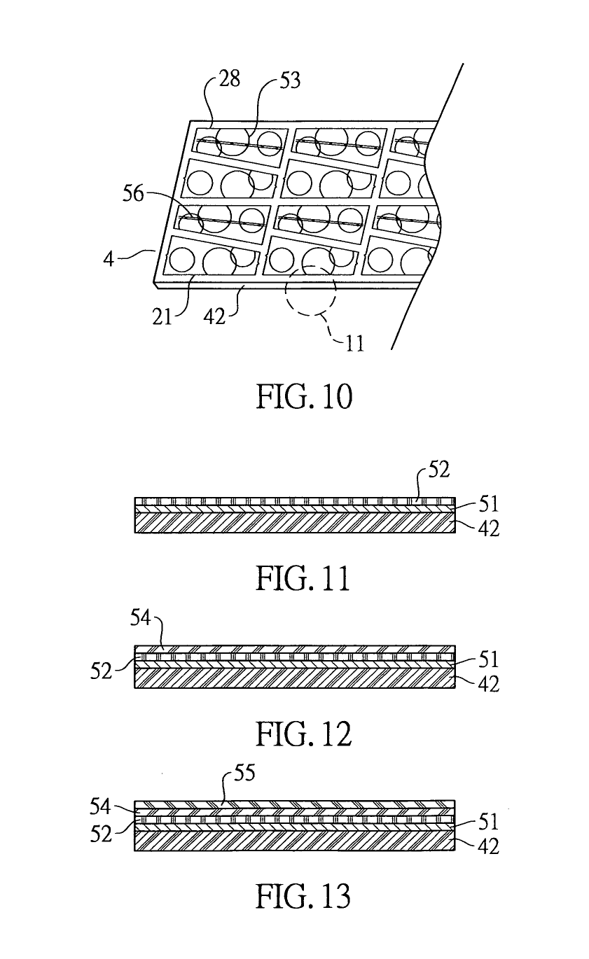

Referring to FIGS. 10 and 11, the contours 21, 28, the photographic image 53, the colour central mark system 56 are printed onto the ink receiving layer 51 as they are designed and saved in the digital image data file 6. The inkjet ink is a water based ink. Its water content is absorbed by the ink receiving layer 51 so as to form a decorative layer 52 on the ink receiving layer 51 (FIG. 11). The contours, 21, 28, the photographic image 53, and the colour central mark system 56 are printed in one digital inkjet printing step and form a ink film (namely the decorative layer 52, FIG. 10). The digital inkjet printing step is defined as a printing step of a digital imaging work flow that delivers a digital data file containing variant digital image data from computer to inkjet printer in order to print images on a receiving material.

In order to protect the ink film of the decorative layer 52, an UV coating is flow-coated on the top of the decorative layer 52.

The UV coating is a conventional energy curable coating, containing the following basic components: (1). Acrylic resins—Primary resin family of UV-curable materials. Monomers are low- molecular-weight acrylates contributing the physical features such as hardness, softness, elasticity. Oligomers are high-molecular-weight acrylates which have the physical features from materials such as urethane, polyesters, silicon etc. (2). Photoiniator—an UV light sensitive material, such as aromatic onium salt, for absorbing UV light and starting the polymerizing free-radical reaction. The polymerization is the reaction by which Monomers (and Oligomers) are converted into high molecular weight materials (polymers). (3) Fillers and Additives—for providing adhesion, surface features such as gloss, slip, filling features of porous substrates and so on.

The UV coating is cured by UV light to immediately harden and form an image protecting layer 54 (FIG. 12). This image protecting layer 54 can be water resistant, abrasive resistant and solvent resistant so as to protect the images on the decorative layer 52, and especially to resist a solvent used in the next anti-slip coating step. At this image protect coating step, the sheet material 4 is sequentially placed with the ink receiving layer 51, the decorative layer 52, and the image protecting layer 54 thereon (FIG. 12).

Further, a polymer in a liquid form is coated by a roll coater and heat-cured on the top of the image protecting layer 54 so as to form a soft anti-slip contact layer 55. This polymer is a conventional anti-slip polymer, such as a cross-linked acrylic polymer, a plasticized polyvinyl chloride elastomer or silicon rubber or a polyurethane elastomer, and it is able to form a solid film by evaporating its solvent. This solid film provides the contact layer 55 with a soft anti-slip feel. After this anti-slip coating step is finished, the sheet material 4 is now sequentially layered with the ink receiving layer 51, the decorative layer 52, the image protecting layer 54, and the contact layer 55 (FIG. 13).

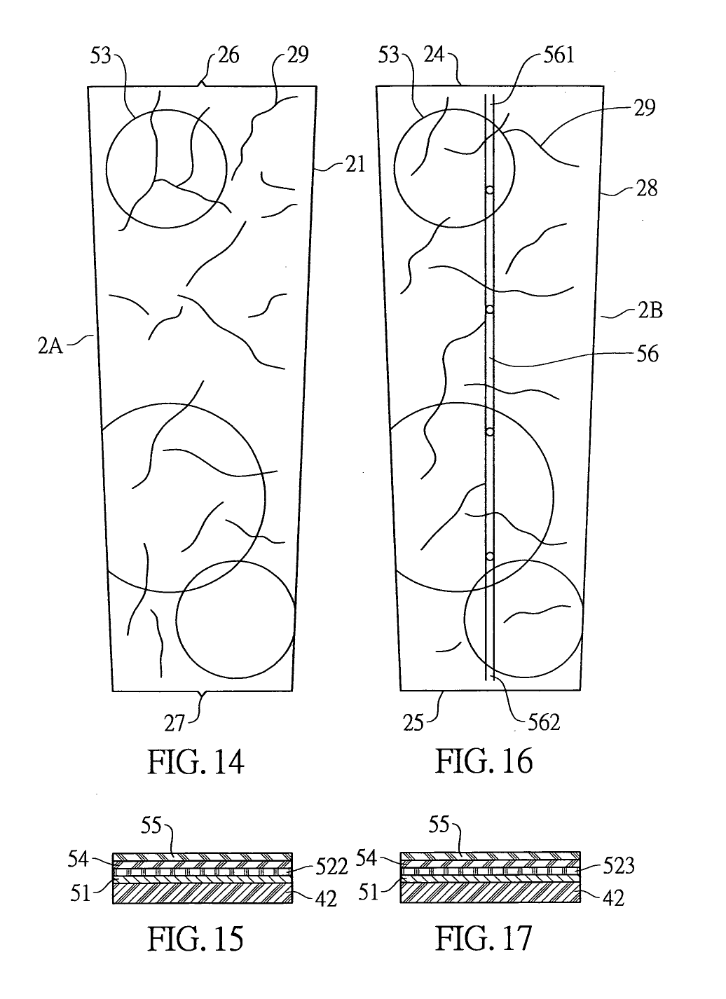

Next step is a die-cut and embossing step. A die is used to die-cut the sheet materials 4, so as to process the ink receiving layer 51, the decorative layer 52, the image protecting layer 54, and the contact layer 55 into a single panel form of the single panel gripping members 2A and 2B. At the same time, the single panel gripping members 2A and 2B are embossed to provide them respectively with an indented surface pattern 29. The die is a metal plate having a knife-edge cutting blade and a shallower level die depth. Its knife-edge cutting blade is used to cut the sheet material 4 into the single panel form. Its shallower level die depth is to produce the indented surface pattern 29 on the single panel gripping members 2A and 2B (FIG. 14, 16).

Referring to FIGS. 10, 13, 14, 15, the single panel gripping member 2A is in the single panel form and has a panel decorative layer 522 die-cut from the decorative layer 52 of the sheet material 4. At this stage, the single panel gripping member 2A has the contour 21, the panel central marks 26, 27, the indented surface pattern 29, the photographic image 53, but without colour central mark system 56.

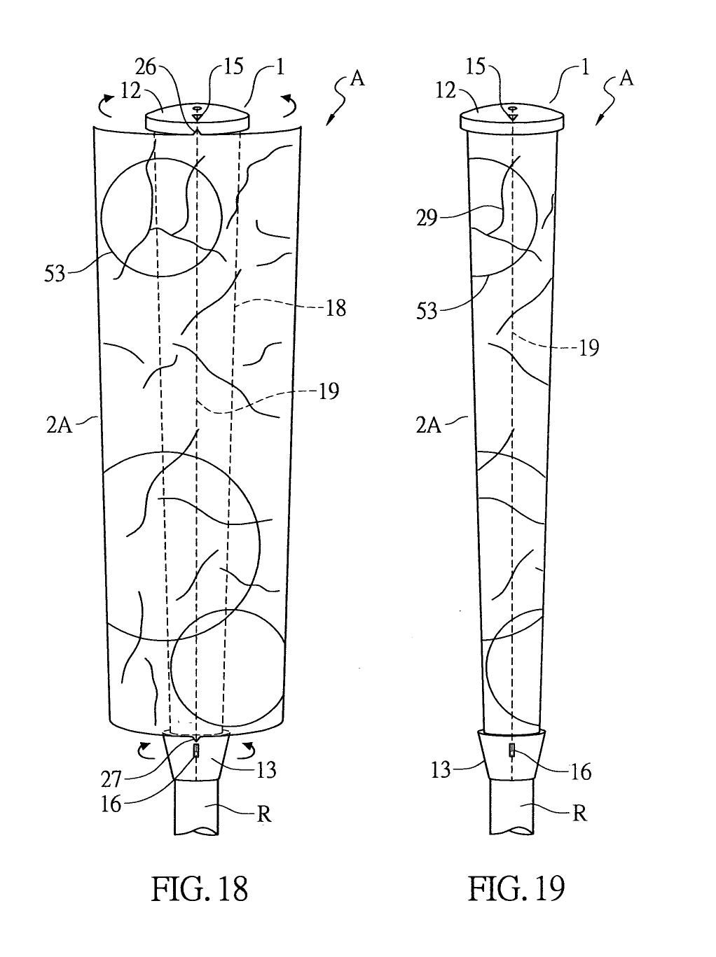

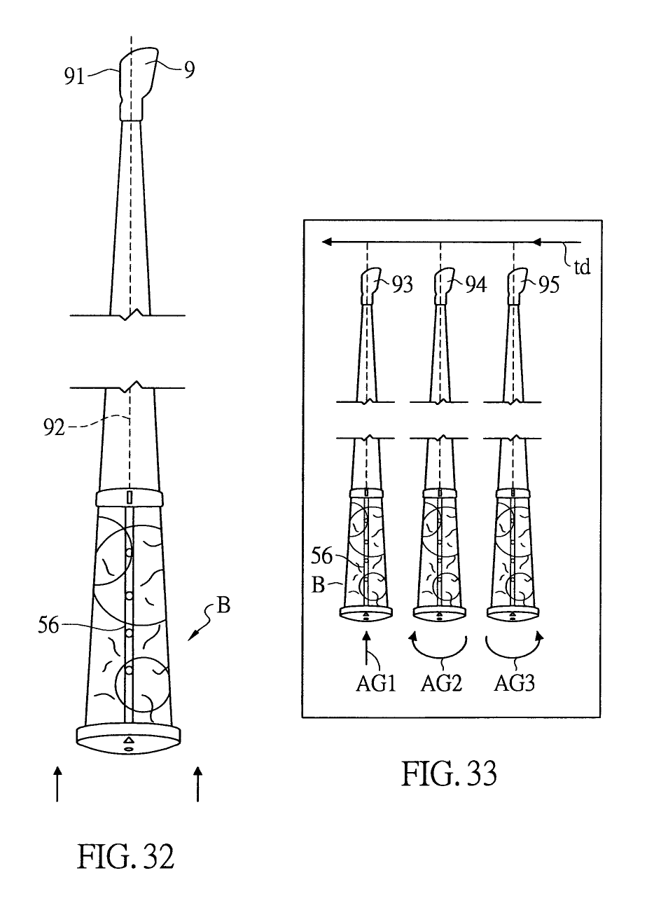

To assemble the first embodiment of the present invention (golf club grip A), the back side (the side without photographic image 53) of the single panel gripping member 2A is coated with cement or taped with double-side adhesive tape. Referring to FIGS. 18 and 19, the resilient inner sleeve 1 is mounted on a rod R. The single panel gripping member 2A's panel central marks 26, 27 are aligned with the axial central front area 19 of the resilient inner sleeve 1. This alignment is to ensure that the photographic image 53 of the single panel gripping member 2A is properly (or preferably) located for better visual effects of the golf club grip A and that the single panel gripping member 2A is correctly assembled together with the resilient inner sleeve 1 for improving the good production rate. The axial central front area 19 can be marked by means of the two sleeve central marks 15, 16 (FIG. 2) or by means of the colour laser beam emitted from a pointer device. The colour laser beam is projected to optically mark the designated central area, namely the axial central front area 19 referred by the reference mark on the resilient inner sleeve 1. The designated central area is in the path of the conventional golf club grip installation direction 191 to mount the golf club grip onto the golf club shaft (FIGS. 2 and 32). The single panel gripping member 2A is wrapped around and adhered onto the outer surface 18 of the tubular sleeve body 11.

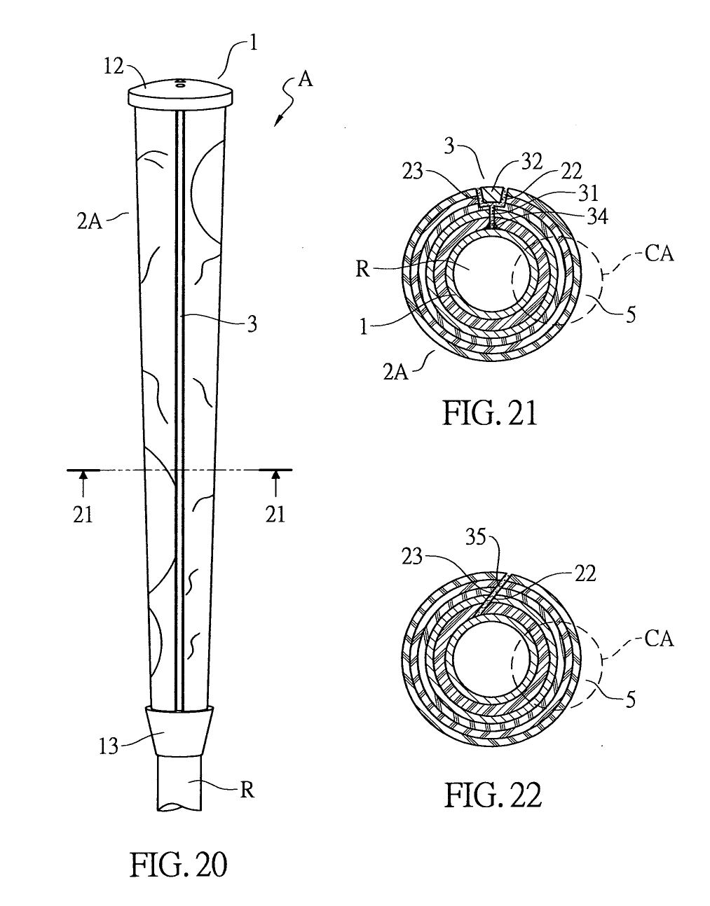

Referring to FIGS. 20 and 21, the single panel gripping member 2A's two axial margins 22, 23 are connected and longitudinally finished with the axial seam structure 3 provided between the cap 12 and protective rim 13 to form the first embodiment of the golf club grip A according to the present invention.

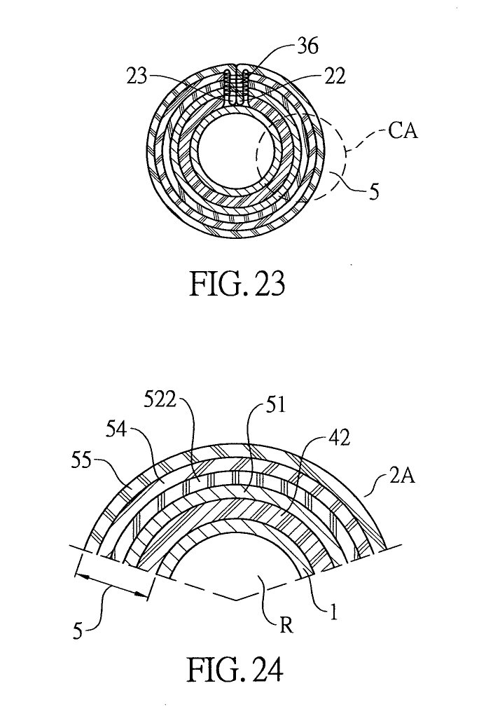

The axial seam structure 3 can be a structure disclosed in U.S. Pat. No. 8,480,508 (Chu et al), where the structure includes an axial gap 31 between two axial margins 22, 23 filled with a structural cement 34 to strengthen the bonding between two axial margins 22, 23 and the resilient inner sleeve 1, and an axial seam strip 32 connecting the two margins 22, 23 and covering the axial gap 31 (FIG. 21). The axial seam structure 3 also can be another axial seam structure disclosed in U.S. Pat. No. 3,857,745 (Grauch et al), where the two axial margins 22, 23 are skived and adhered together with a bevelled bonding part 35 (FIG. 22). The axial seam structure 3 can still be another axial seam structure disclosed in U.S. Pat. No. 3,366,384 (Lamkin et al), where the two axial margins 22, 23 are inwardly sewn together with a set of stitching threads 36 (FIG. 23).

Referring to FIG. 24, the single panel golf club grip A has the resilient inner sleeve 1 as an inner layer and the single panel gripping member 2A as an outer layer. The single panel gripping member 2A further has a laminate-layered structure 5. The laminate-layered structure 5 is arranged in a layered structure order from an inner base outwardly to an external surface and sequentially includes: the substrate layer 42 as the first layer and the inner base for providing a cushion and torque resistant strength; the ink receiving layer 51 as the second layer for forming a medium layer adhered to the substrate layer 42 and receiving the water content of the third layer's ink; the panel decorative layer 522 as the third layer for carrying the photographic image 53; the image protecting layer 54 as the fourth layer for protecting the photographic image 53; and the contact layer 55 as the fifth layer and the external surface for providing the soft anti-slip feel for golf players.

Referring to FIGS. 19 and 24, the first embodiment of the golf club grip A according to the present invention has the single panel gripping member 2A that contains a combination of the ink receiving layer 51 and the panel decorative layer 522 to provide the photographic image 53 to have an aesthetical appearance; the contact layer 55 combined with the image protecting layer 54 to protect the photographic image 53 and to provide a soft anti-slip contact feel for golf players.

The single panel gripping member 2A's panel central marks 26, 27 are aligned with the axial central front area 19 of the resilient inner sleeve 1. This alignment is to have the photographic image 53 properly (or preferred) located for better visual effects of the golf club grip A and to properly assemble the single panel gripping member 2A together with the resilient inner sleeve 1 for improving the good production rate (FIG. 19).

The photographic image 53 is printed in one single digital inkjet printing step so as to perform the printing process in a simple and cost effective way.

Thus, the three objects of the present invention are accomplished in the first embodiment of the golf club grip A according to the present invention.

Referring to FIGS. 10, 13, 16, 17, the single panel gripping member 2B is in the single panel form and has a panel decorative layer 523 die-cut from the decorative layer 52 of the sheet material 4. At this stage, the single panel gripping member 2B has the contour 28, the indented surface pattern 29, the photographic image 53, and the colour central mark system 56, but without panel central marks 26, 27 (FIGS. 16, 17).

The colour central mark system 56 is used to indicate the axial central area of the single panel gripping member 2B and can be an inkjet mark consisting of a group of symbols selected from dots, lines, signs, logos, wordings, graphic patterns, and the combinations thereof. It is extended between the top and bottom margins 24, 25 of the single panel gripping member 2B and has its top and bottom parts 561, 562 respectively near the top and bottom margins 24, 25 (FIG. 16).

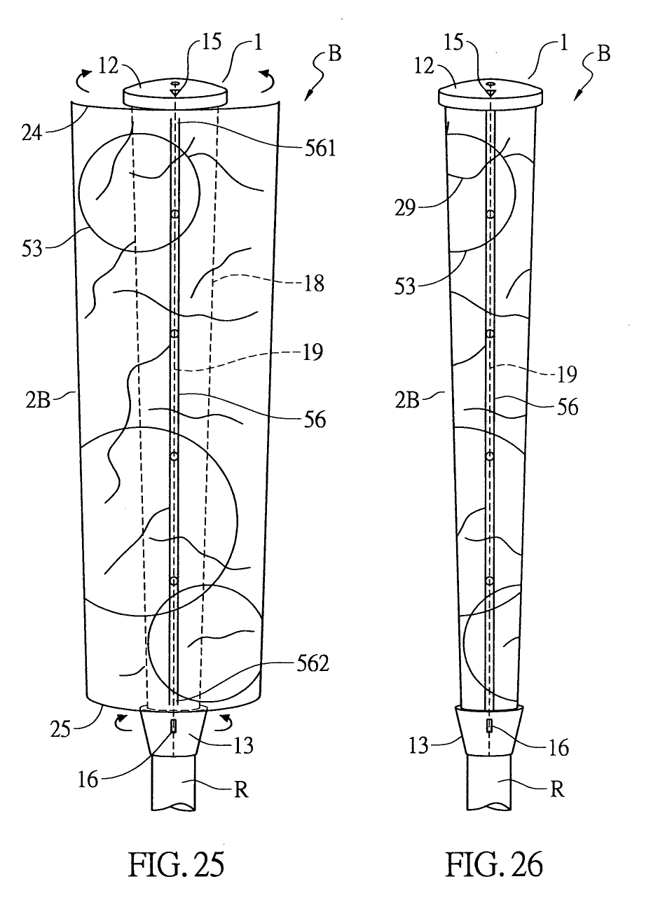

To assemble the second embodiment of the golf club grip B according to the present invention, the back side (the side without the photographic image) of the single panel gripping member 2B is coated with cement or taped with double-side adhesive tape. Referring to FIGS. 25, 26, the resilient inner sleeve 1 is mounted on the rod R. The top and bottom parts 561, 562 of the colour central mark system 56 are aligned with the axial central front area 19 of the resilient inner sleeve 1. This alignment is to ensure that the photographic image 53 of the single panel gripping member 2B can be properly (or preferably) located for better visual effects of the golf club grip B and that the single panel gripping member 2B can be assembled correctly together with the resilient inner sleeve 1 for improving good production rate. The axial central front area 19 is marked by means of the sleeve central marks 15, 16 (FIG. 2) or by means of the colour laser beam emitted from a pointer device. The colour laser beam is projected to be aligned with the reference mark on the resilient inner sleeve 1, so that the designated central area (that is, the axial central front area 19) can be optically marked. The designated central area is in the path of conventional golf club grip installation direction 191 for mounting the golf club grip onto the golf club shaft (FIG. 2, 32). The single panel gripping member 2B is wrapped around and adhered onto the outer surface 18 of the tubular sleeve body 11.

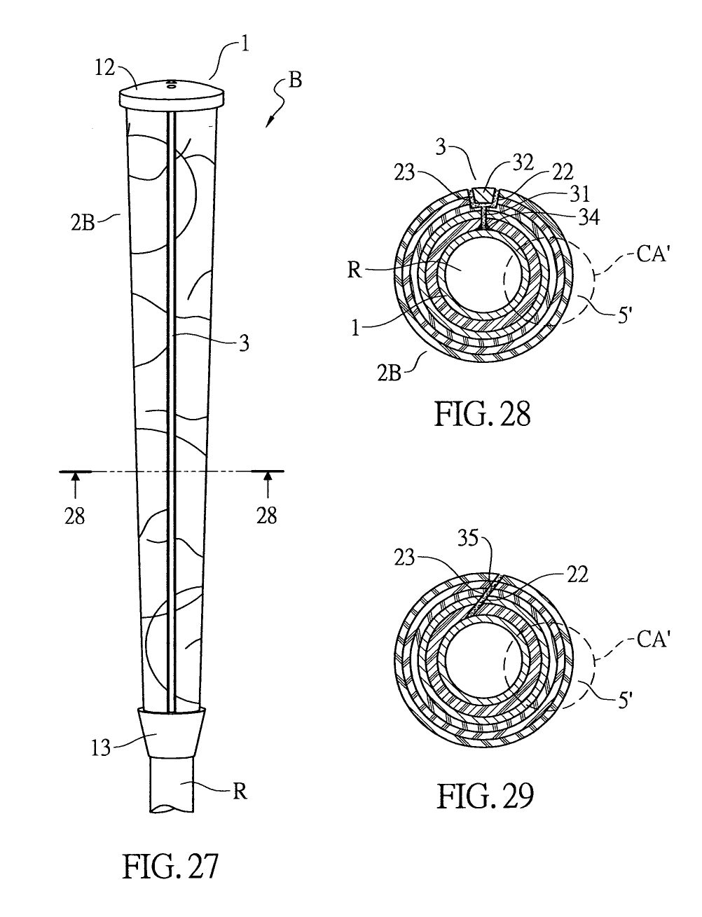

Referring to FIGS. 27, 28, the single panel gripping member 2B's two axial margins 22, 23 are connected and longitudinally finished with the axial seam structure 3 provided between the cap 12 and protective rim 13 so as to form the second embodiment of the golf club grip B according to the present invention.

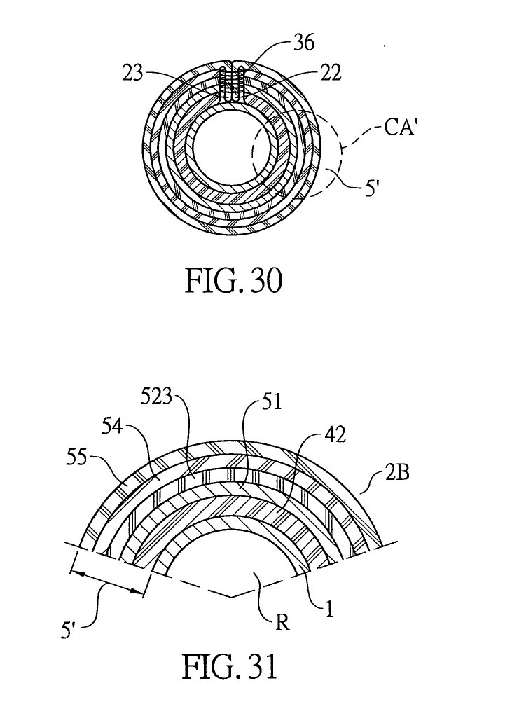

The axial seam structure 3 can be a structure disclosed in U.S. Pat. No. 8,480,508 (Chu et al) and includes: an axial gap 31 between two axial margins 22, 23 filled with a structural cement 34 to strengthen the bonding between two axial margins 22, 23 and the resilient inner sleeve 1; and an axial seam strip 32 connecting two axial margins 22, 23 and covering the axial gap 31 (FIG. 28). The axial seam structure 3 also can be another axial seam structure disclosed in U.S. Pat. No. 3,857,745 (Grauch et al) and includes two axial margins 22, 23 skived and adhered together with a bevelled bonding part (FIG. 29). The axial seam structure 3 can still be another axial seam structure disclosed in U.S. Pat. No. 3,366,384 (Lamkin et al) and includes two axial margins 22, 23 inwardly sewn together with a set of stitching threads 36 (FIG. 30).

Referring to FIG. 31, the single panel golf club grip B has the resilient inner sleeve 1 as the inner layer and the single panel gripping member 2B as the outer layer. The single panel gripping member 2B further has a laminate-layered structure 5′ that has a layered structure order. The layered structure order is arranged from the inner base outwardly to the external surface and sequentially include following layers: the substrate layer 42 as the first layer and the inner base for providing a cushion and torque resistant strength; the ink receiving layer 51 as the second layer for forming a medium adhered to the substrate layer 41 and receiving the water content of the third layer's ink; the panel decorative layer 523 as the third layer having the photographic image 53 and the colour central mark system 56; the image protecting layer 54 as the fourth layer for protecting the photographic image 53 and the colour central mark system 56; and the contact layer 55 as the fifth layer and external surface for providing the soft anti-slip feel for golf players.

Referring to FIGS. 26, 31, the second embodiment of the golf club grip B according to the present invention comprises the single panel gripping member 2B that has a combination of following layers: the ink receiving layer 51 and the panel decorative layer 523 with the photographic image 53 and the colour central mark system 56 for providing the aesthetical appearance (FIG. 26); the contact layer 55 combined with the protective layer 54 to protect the photographic image 53 and the colour central mark system 56 on the panel decorative layer 523 and to provide a soft anti-slip contact feel for golf players (FIG. 31).

The colour central mark system 56 together with its top and bottom parts 561, 562 are aligned with the axial central front area 19 of the resilient inner sleeve 1. This alignment is to ensure that the photographic image 53 is properly (or preferably) located for better visual effects of the golf club grip B (FIG. 26) and that the single panel gripping member 2B is properly assembled together with the resilient inner sleeve 1 for improving the good production rate.

The photographic image 53 and the colour central mark system 56 are printed in one single digital inkjet printing step to make the printing simple and cost effective.

Thus, the three objects of the present invention are accomplished in the second embodiment of the golf club grip B according to the present invention.

Additionally, since the golf club grips are made of resilient material, they may easily be rotationally deformed during the grip installation. The colour central mark system 56 of the golf club grip B can visually improve the accurate alignment of the grip with respect to a golf club head face 9 (FIG. 32) during and after the grip installation.

Whether the golf club grip B is properly installed can be checked as follows: to place a golf club, which is mounted with the golf club grip B, in playing position (where the golf club head is on the ground and the grip upwardly for golf players to hold) to see whether the golf club grip B's colour central mark system 56 and a shaft center 92 of a golf shaft are parallel to a leading edge 91 of the golf club head face 9 (FIG. 32). If any adjustment for the golf club grip B is required, it should be finished in 2 to 3 minutes after the grip installation before the solvent used in this grip installation evaporates. In other words, the colour central mark system 56 and the shaft center 92 of the golf shaft could be adjusted to be parallel to the leading edge 91 of the golf club head face 9 only before the solvent evaporates.

In FIG. 33, all three golf club head faces 93, 94, 95 are square to a direction towards the target (td). The most common grip installation is to align the colour central mark system 56 to be perfectly square to the target direction (td) (square alignment, AG1) so as to have a square golf club head face. Upon golf players' preference, the golf grip installers can turn the golf club grip B and the colour central mark system 56 slightly left (left alignment, AG2) from the square alignment (AG1) position to have an open golf club head face with respect to the colour central mark system 56, or turn the golf club grip B and the colour central mark system 56 slightly right (right alignment, AG3) from the square alignment (AG1) position to have a closed golf club head face with respect to the colour central mark system 56.

In some embodiments, the single panel gripping members 2A, 2B of the golf club grips A, B can have their substrate layer 42 made of a natural leather (such as split leather), or other synthesized leather materials containing collagen fiber (such as bonded leather). Their surface can be improved and upgraded with the combination of the ink receptive layer 51, the panel decorative layer 522, 523 having the photographic image 53 for the aesthetic appearance, and the image protecting layer 54 and the contact layer 56 for providing water and abrasive resistant features and soft anti-slip contact feel, so as to achieve the three objects of the present invention. Additionally, compared with the conventional natural leather golf club grip, above golf club grips can provide natural leather's soft feel and torque resistant strength with low prices due to their material's collagen fiber and cost.

It should be noted that in the above embodiments, the single panel golf club grips A, B could all be modified into a putter grip. This modification is done by replacing the resilient inner sleeve 1 with a different resilient inner sleeve which has a non-circular cross-sectional sleeve body with a flat front area (not shown). The configuration of the flat front area is in accordance with the design of most putters in general use.

The present invention has been described in above embodiments that are considered the most practical and preferable ones. It should be understood that the present invention is not limited to the disclosed embodiments but is intended to cover various arrangements included within the spirit and scope of the broadest interpretation so as to encompass all such modifications and equivalent arrangements.

We claim:

1. A golf club grip-club grip, comprising:
a resilient inner sleeve, having a tubular sleeve body, a cap projecting radially from a first end of the sleeve body and closed with a vent hole, a protective rim projecting radially from a second end of the sleeve body with an opening, a cavity configured to receive a larger end of a golf club shaft, an axial central front area between the vent hole and the opening, and an outer surface of the tubular sleeve body extended from the cap to the protective rim;
a single panel gripping member, having a top margin, a bottom margin, two axial margins, at least a panel central mark located at a position in an area from the top margin to the bottom margin, and a laminate-layered structure;
wherein the laminate-layered structure has a substrate layer, an ink receiving layer, a panel decorative layer, an image protecting layer, and a contact layer arranged in a layered structure order;
wherein the layered structure order is outwardly from an inner base to an external surface as follow:
the substrate layer is the first layer as the inner base,
the ink receiving layer is the second layer,
the panel decorative layer is the third layer,
the image protecting layer is the fourth layer, and
the contact layer is the fifth layer as the external surface;
wherein the panel decorative layer has a one-color or multi-color inkjet photographic image;
wherein the ink receiving layer is adhered to the substrate layer and used to absorb the water content of a water based ink of the photographic image;
wherein the image protecting layer is formed by an UV coating;
wherein the contact layer is formed by an anti-slip polymer;
wherein the anti-slip polymer is selected from a group consisting of a cross-linked acrylic polymer, a plasticized polyvinyl chloride elastomer, a silicon rubber, and a polyurethane elastomer;
wherein the panel central mark is aligned with the axial central front area of the resilient inner sleeve;
wherein a dimension of the single panel gripping member together with an axial seam structure from the top margin to the bottom margin is sufficient to cover the outer surface of the tubular sleeve body;
wherein the single panel gripping member is wrapped around and adhered onto the tubular sleeve body of the resilient inner sleeve; and
wherein the two axial margins of the single panel gripping member are held together by means of the axial seam structure between the cap and protective rim of the resilient inner sleeve.

2. The golf club grip as claimed in claim 1, wherein the axial central front area of the resilient inner sleeve is marked by means of two sleeve central marks, and the two sleeve central marks are respectively located at the cap and the protective rim of the resilient inner sleeve.

3. The golf club grip as claimed in claim 1, wherein the axial central front area of the resilient inner sleeve is provided with a reference mark thereon for being aligned with a color laser beam emitted from a pointer device.

4. The golf club grip as claimed in claim 1, wherein the photographic image is a photo image or an image having a color range and a clear shape as a photo in accuracy or detail.

5. The golf club grip as claimed in claim 4, wherein a central part of the photographic image is aligned with the axial central front area of the resilient inner sleeve.

6. The golf club grip as claimed in claim 1, wherein the panel central mark is a colour central mark system located between the top and bottom margins of the single panel gripping member, and the colour central mark system is an inkjet mark consisting of a group of symbols selected from dots, lines, signs, logos, wordings, graphic patterns and the combinations thereof.

7. The golf club grip as claimed in claim 1, wherein the panel central mark is a couple of panel central marks respectively located at the top and bottom margin of the single panel gripping member.

8. The golf club grip as claimed in claim 1, wherein the substrate layer is made of a material selected from a group consisting of synthetic leather, PU (Polyurethane) leather, PU wet type leather, PU/closed-cell foam leather, water based PU (Polyurethane) leather, natural leather, leather/closed-cell foam layered material, split leather, synthesized leather, bonded leather, and material containing collagen fiber.

9. The golf club grip as claimed in claim 8, wherein the substrate layer is made of a material selected from a group consisting of split leather, synthesized leather, bonded leather, and material containing collagen fiber.

10. The golf club grip as claimed in claim 1, wherein the ink receiving layer is formed by a water-absorbing polymer including a water-absorbing cationic polymer or a water-absorbing anionic polymer.

11. A method of making a golf club grip, comprising steps of:
providing a resilient inner sleeve, which includes a tubular sleeve body, a cap projecting radially from a first end of the sleeve body and closed with a vent hole, a protective rim projecting radially from a second end of the sleeve body with an opening, a cavity configured to receive a larger end of a golf club shaft, an axial central front area between the vent hole and the opening, and an outer surface of the tubular sleeve body extended from the cap to the protective rim;
providing a single panel gripping member, which includes a top margin, a bottom margin, two axial margins, at least a panel central mark located at a position in an area from the top margin to the bottom margin, and a laminate-layered structure,
wherein the laminate-layered structure has a substrate layer, an ink receiving layer, a panel decorative layer, an image protecting layer, and a contact layer arranged in a layered structure order;
wherein the layered structure order is outwardly from an inner base to an external surface as follow:
the substrate layer is the first layer as the inner base,
the ink receiving layer is the second layer,
the panel decorative layer is the third layer,
the image protecting layer is the fourth layer,
the contact layer is the fifth layer as the external surface;
wherein the panel decorative layer has a one-color or multi-color photographic image printed in a digital inkjet printing step;
wherein the ink receiving layer is adhered to the substrate layer and used to absorb the water content of a water based ink of the photographic image;
wherein the image protecting layer is formed by an UV coating;
wherein the contact layer is formed by an anti-slip polymer;
wherein the anti-slip polymer is selected from a group consisting of a cross-linked acrylic polymer, a plasticized polyvinyl chloride elastomer, a silicon rubber and a polyurethane elastomer;
wherein the panel central mark is aligned with the axial central front area of the resilient inner sleeve,
wherein a dimension of the single panel gripping member together with an axial seam structure from the top margin to bottom margin is sufficient to cover the outer surface of the tubular sleeve body,
wherein the single panel gripping member is wrapped around and adhered onto the tubular sleeve body of the resilient inner sleeve; and
wherein two axial margins of the single panel gripping member are held together by means of said axial seam structure between the cap and protective rim of the resilient inner sleeve.

12. The method as claimed in claim 11, further comprising a step of:
aligning the resilient inner sleeve with the single panel gripping member by means of two sleeve central marks provided on the axial central front area of the resilient inner sleeve, wherein the two sleeve central marks are respectively located at the cap and the protective rim of the resilient inner sleeve.

13. The method as claimed in claim 11, further comprising a step of:
aligning the resilient inner sleeve with the single panel gripping member by aligning a reference mark provided on the axial central front area of the resilient inner sleeve with a color laser beam emitted from a pointer device.

14. The method as claimed in claim 11, wherein the photographic image is a photo image or an image having a color range and a clear shape as a photo in accuracy or detail; and the digital inkjet printing step is a printing step of printing the photographic image from a digital image data file that is delivered through a computer to an inkjet printer onto the ink receiving layer.

15. The method as claimed in claim 14, wherein a central part of the photographic image is aligned with the axial central front area of the resilient inner sleeve.

16. The method as claimed in claim 11, wherein the panel central mark is a colour central mark system located between the top and bottom margins of the single panel gripping member, and the colour central mark system is an inkjet mark consisting of a group of symbols selected from dots, lines, signs, logos, wordings, graphic patterns and the combinations thereof.

17. The method as claimed in claim 11, wherein the panel central mark is a couple of panel central marks respectively located at the top and bottom margin of the single panel gripping member.

18. The method as claimed in claim 11, wherein the substrate layer is made of a material selected from a group consisting of synthetic leather, PU (Polyurethane) leather, PU wet type leather, PU/closed-cell foam leather, water based PU (Polyurethane) leather, natural leather, leather/closed-cell foam layered material, split leather, synthesized leather, bonded leather, and material containing collagen fiber.

19. The method as claimed in claim 18, wherein the substrate layer is made of a material selected from a group consisting of split leather, synthesized leather, bonded leather, and material containing collagen fiber.

20. The method as claimed in claim 11, wherein the ink receiving layer is formed by a water-absorbing polymer including a water-absorbing cationic polymer or a water-absorbing anionic polymer.
